(19) United States
(12) Patent Application Publication
(10) Pub. No.: US 2023/0161030 A1
(43) Pub. Date: May 25, 2023

(54) RADAR CONTROL DEVICE AND METHOD

(71) Applicant: HL Klemove Corp., Incheon (KR)

(72) Inventor: Jong Gu KANG, Yongin-si (KR)

(73) Assignee: HL Klemove Corp., Incheon (KR)

(21) Appl. No.: 17/984,512

(22) Filed: Nov. 10, 2022

(30) Foreign Application Priority Data
Nov. 19, 2021 (KR) 10-2021-0160536

(51) Int. Cl. G01S 13/931; G01S 13/89

(52) U.S. Cl. CPC G01S 13/931; G01S 13/89

(57) ABSTRACT

The embodiments of the present disclosure relate to a radar control device and method. Specifically, a radar control device according to the present disclosure may include a receiver configured to receive vehicle surrounding information about surroundings of a host vehicle from a radar sensor, a map generator configured to determine a measurement value of the radar sensor for an object from the vehicle surrounding information, determine a detection probability for the measurement value, and generate a predicted occupancy probability grid map based on the detection probability, and a determiner configured to determine a free space in which the host vehicle can travel based on the predicted occupancy probability grid map.

### CROSS REFERENCE TO RELATED APPLICATION

This application claims priority from Korean Patent Application No. 10-2021-0160536, filed on Nov. 19, 2021, which is hereby incorporated by reference for all purposes as if fully set forth herein.

### TECHNICAL FIELD

The present embodiments of the present disclosure relate to a radar control device and method.

Recently, there is being actively conducted the development of a driver assistance system (DAS) and autonomous driving using a radar device mounted on a vehicle.

To this end, the vehicle radar is required to perform a function of acquiring various information about a target around the vehicle by analyzing a reception signal which the transmission signal is reflected off the object and is received to acquire various information about the target around the vehicle.

In addition, the information provided by the radar device may be used for autonomous driving and various advance driver assistance systems (ADAS). Specifically, it is possible to determine where the vehicle can travel by classifying targets existing within the detection range of the radar device.

### SUMMARY

In this background, the present disclosure may provide a radar control device and method capable of generating a predicted occupancy probability grid map for an object based on a signal received from a radar sensor, and determining free space around a host vehicle based on the predicted occupancy probability grid map.

In an aspect of the present disclosure, there is provided a radar control device including a receiver configured to receive vehicle surrounding information about surroundings of a host vehicle from a radar sensor, a map generator configured to determine a measurement value of the radar sensor for an object from the vehicle surrounding information, determine a detection probability for the measurement value, and generate a predicted occupancy probability grid map based on the detection probability, and a determiner configured to determine a free space in which the host vehicle can travel based on the predicted occupancy probability grid map.

In another aspect of the present disclosure, there is provided a radar control method including receiving vehicle surrounding information about surroundings of a host vehicle from a radar sensor, determining a measurement value of the radar sensor for an object from the vehicle surrounding information, determining a detection probability for the measurement value, and generating a predicted occupancy probability grid map based on the detection probability, and determining a free space in which the host vehicle can travel based on the predicted occupancy probability grid map.

According to the present disclosure, the radar control device and method generates a predicted occupancy probability grid map for an object based on a signal received from a radar sensor, sets an object area based on the predicted occupancy probability grid map, and determines a stationary object and a free space around the host vehicle, so that it is possible to more accurately determine stationary objects and free space.

### BRIEF DESCRIPTION OF THE DRAWINGS

FIG. 1 schematically illustrates a radar control device according to an embodiment of the present disclosure.

FIG. 2 illustrates an occupancy probability model for one sample object according to an embodiment of the present disclosure.

FIG. 3 illustrates a predicted occupancy probability grid map according to an embodiment of the present disclosure.

FIG. 4 is a diagram for explaining setting of an object area according to an embodiment of the present disclosure.

FIG. 5 is a diagram for explaining determining a stationary object based on an object area according to an embodiment of the present disclosure.

FIG. 6 is a diagram for explaining determining a free space based on an object area according to an embodiment of the present disclosure.

FIG. 7 is a flowchart illustrating a radar control method according to an embodiment of the present disclosure.

FIG. 8 is a diagram for describing in detail determining a free space of a radar control method according to an exemplary embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described a radar control device 10 according to an embodiment of the present disclosure with reference to the accompanying drawings.

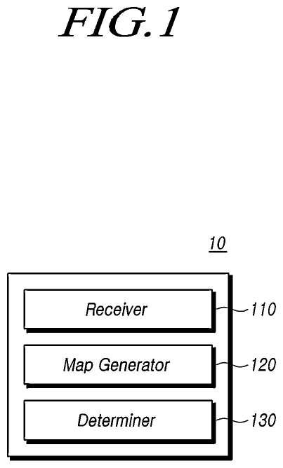

FIG. 1 schematically illustrates a radar control device 10 according to an embodiment of the present disclosure.

Referring to FIG. 1, a radar control device 10 according to an embodiment of the present disclosure may include a receiver 110, a map generator 120, and a determiner 130.

The radar control device 10 according to an embodiment of the present disclosure may be mounted on a host vehicle and may provide information used for autonomous driving of the host vehicle or used for performing an advance driver assistance systems (ADAS) for assisting the driver in controlling the host vehicle. For example, the radar control device 10 according to an embodiment of the present disclosure may determine a free space and provide information on the determined free space to allow the host vehicle to autonomously drive or to perform ADAS.

Here, the ADAS may include various types of advanced driver assistance systems, for example, an autonomous emergency Braking system (AEB), a smart parking assistance system (SPAS), a blind spot detection system (BSD), an adaptive cruise control (ACC) system, a lane departure warning system (LDWS), a lane keeping assist system (LKAS), a lane change assist system (LCAS) and the like. However, the present disclosure is not limited thereto, and may further include a well-known driver assistance system capable of assisting the driver in controlling the host vehicle.

The receiver 110 may receive information about the vehicle surrounding the host vehicle from the radar sensor.

Here, the radar sensor may include an antenna unit, a radar transmitter, and a radar receiver.

The antenna unit may include one or more transmission antennas and one or more receiving antennas, and each transmission/receiving antenna may be an array antenna in which one or more radiating elements are connected in series by a feed line, but is not limited thereto.

The antenna unit may include a plurality of transmission antennas and a plurality of receiving antennas, and may include various types of antenna array structures according to an arrangement order and an arrangement interval thereof.

The radar transmitter may provide a function of transmitting a transmission signal through a switched transmission antenna by switching the radar to one of a plurality of transmission antennas included in the radar or transmitting a transmission signal through a multi-transmission channel allocated to the plurality of transmission antennas.

The radar transmitter may include an oscillator for generating a transmission signal for one transmission channel allocated to the switched transmission antenna or multi-transmission channels allocated to a plurality of transmission antennas. The oscillator may include, for example, a voltage-controlled oscillator (VCO) and an oscillator.

The radar receiver may receive a reception signal received by being reflected from an object through a receiving antenna.

In addition, the radar receiver may provide a function of receiving a reception signal, which is a reflection signal of the transmission signal reflected by a target, through the switched reception antenna by switching to one of a plurality of receiving antennas, or a function of receiving a reception signal through multi-receiving channels allocated to a plurality of receiving antennas.

The radar receiver may include a low-noise amplifier (LNA) for low-noise amplification of a reception signal received through one receiving channel allocated to the switched receiving antenna or received through a multi-receiving channel allocated to a plurality of receiving antennas, a mixer for mixing the low-noise amplified reception signal, an amplifier for amplifying the mixed reception signal, and a converter (e.g., an analog digital converter) for digitally converting the amplified reception signal to generate reception data.

The vehicle surrounding information received by the above-described receiver 110 may be a radar reception signal or digitally converted reception data.

The map generator 120 may determine or calculate a radar measurement value for an object based on vehicle surrounding information, determine a detection probability for the measurement value, and generate a predicted occupancy probability grid map based on the detection probability.

The measurement value may be determined by performing Fast Fourier Transform (FFT) on vehicle surrounding information.

Specifically, the radar sensor may transmit and receive a fast-chirp signal around the host vehicle through the radar transmitter unit and radar receiver 110. To this end, the radar sensor may be a fast chirp radar sensor.

The map generator 120 may calculate a range and a time component by performing a 1st FFT on the vehicle surrounding information, and perform a 2nd FFT on the time again to acquire a range and a speed (Doppler) component.

The map generator 120 may calculate or determine a detection probability for the measurement value based on a preset occupancy probability model.

The map generator 120 may calculate the detection probability using a preset occupancy probability model with respect to the measurement value determined as described above.

The occupancy probability model may be preset by calculating the detection probability for each measurement value based on the measurement value for the sample object. In addition, noise may be included in the measurement value calculated from the vehicle surrounding information, and the occupancy probability model may be set by reflecting the detection probability in consideration of the noise characteristic.

In addition, the occupancy probability model may be set based on the detection probability calculated by dividing the location of the sample object and the surrounding area of the sample object. In the case of a vehicle radar sensor, the location of the object is extracted using the peak value of the reception signal, but there is a possibility that the sample object also occupies an area around the sample object. Therefore, in calculating the detection probability, it is required to be considered not only the location of the sample object but also the surrounding area of the sample object. By applying a Gaussian model to the detection probability for the location of the sample object, the detection probability of the sample object with respect to the surrounding area may be calculated. In addition, the occupancy probability model may be set based on the detection probability in which the location of the sample object and the surrounding area of the sample object are separated. Since the predicted occupancy probability is determined based on the detection probability considering the location of the sample object as well as the surrounding area of the sample object, there may be more accurately determined the predicted occupancy probability.

Accordingly, the map generator 120 may calculate a detection probability for each of the calculated measurement values by extracting a detection probability corresponding to the calculated measurement value from the preset occupancy probability model. In this case, the detection probability may have a value between 0 and 1.

In addition, the receiver 110 may further receive vehicle driving information from a plurality of sensors, and the map generator 120 may generate a grid map based on the detection probability and generate a cumulative grid map in which the grid map is updated by using the vehicle driving information.

The receiver 110 may further receive vehicle driving information from a plurality of sensors. The plurality of sensors may include, for example, a vehicle speed sensor and a yaw rate sensor. However, the present disclosure is not limited thereto, and there may be used any sensor capable of confirming driving information of the vehicle.

The map generator 120 may generate a grid map based on the detection probability. An object in the grid map may be generated based on a detection probability determined by considering the location of the object and the surrounding area of the object.

The map generator 120 may generate the cumulative grid map in which the grid map is updated by using the vehicle driving information. For example, the map generator 120 may update the grid map through rigid transformation for an object of which a detection probability is displayed in the grid map using vehicle driving information.

The map generator 120 may generate a cumulative grid map by reflecting the updated grid map on the previously generated grid map. This is to maintain detection probability information on an object until a predicted occupancy probability, which will be described later, is determined.

The receiver 110 may further receive the vehicle surrounding information from the radar sensor every preset period, and the map generator 120 may determine, after the cumulative grid map is generated, the predicted occupancy probability based on the received vehicle surrounding information and the cumulative grid map, and may generate a predicted occupancy probability grid map based on the predicted occupancy probability.

The receiver 110 may further receive the vehicle surrounding information from the radar sensor at preset period. This may be used to update the cumulative grid map every preset period, and may be used to calculate a predicted occupancy probability based on the updated cumulative grid map.

The vehicle surrounding information used to generate the cumulative grid map may be referred to as vehicle surrounding information at a previous time point, and vehicle surrounding information received after the cumulative grid map is generated may be referred to as vehicle surrounding information at the current time point. Hereinafter, description will be provided based on the premise of this time point.

The map generator 120 may determine, after the cumulative grid map is generated, the predicted occupancy probability based on the vehicle surrounding information and the cumulative grid map received.

For example, the map generator 120 may determine a measurement value and a detection probability from vehicle surrounding information at the current time point, and may determine a prior probability for a grid point of which the detection probability is displayed from the cumulative grid map. In addition, the map generator 120 may determine the detection probability for an object at the current time point and a predicted occupancy probability as a posterior predicted probability which is calculated by applying Bayesian Theory to a prior probability calculated from cumulative grid map.

The map generator 120 may generate a predicted occupancy probability grid map based on the predicted occupancy probability. For example, the map generator 120 may generate the predicted occupancy probability grid map by reflecting the determined predicted occupancy probability on the cumulative grid map. Accordingly, the predicted occupancy probability grid map may refer to a grid map in which the predicted occupancy probability determined based on the radar measurement value is reflected.

The map generator 120 may continuously update the predicted occupancy probability map. For example, after the predicted occupancy probability map is generated, the predicted occupancy probability map may be accumulated and updated using vehicle state information received from a plurality of sensors. In addition, the predicted occupancy probability may be determined by using the vehicle surrounding information received from the radar sensor after generating the predicted occupancy probability map and the accumulated/updated predicted occupancy probability map. In addition, the predicted occupancy probability map may be continuously updated by reflecting the calculated predicted occupancy probability in the accumulated/updated predicted occupancy probability map. Therefore, there may be further improved the accuracy of the predicted occupancy probability grid map by updating.

The determiner 130 may determine a free space in which the host vehicle can travel based on the predicted occupancy probability grid map. For example, the determines 130 may extract a point higher than a threshold in the predicted occupancy probability grid map, set an object area based on the extracted point, and determine the free space based on the set object area.

The threshold may be set as a numerical value for the occupancy probability, and may be a reference for determining whether a corresponding point is occupied by an object. The threshold may be preset, but is not limited thereto. For example, the threshold may be variably changed according to the probability distribution of the predicted occupancy probability grid map.

Accordingly, the determiner 130 may determine that a point higher than the threshold, which may be preset in the predicted occupancy probability grid map and may variably change according to the probability distribution of the predicted occupancy probability grid map, is occupied by the object, and may determine that a point lower than the threshold is noise.

The determiner 130 may extract points higher than a threshold, set an area including the extracted points as an object area, and determine a free space based on the set object area. However, the present disclosure is not limited thereto, and the determiner 130 may determine a stationary object based on the set object area.

The radar control device 10 according to the present disclosure may generate a predicted occupancy probability grid map for an object based on a signal received from a radar sensor, set an object area based on the predicted occupancy probability grid map, and determine a stationary object and the free space around the host vehicle based on this, so that it is possible to more accurately determine the stationary object and the free space.

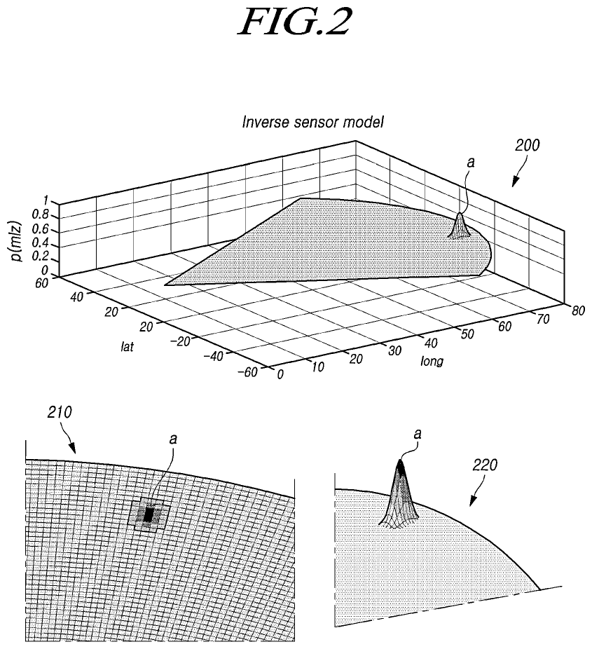

FIG. 2 illustrates an occupancy probability model for one sample object according to an embodiment of the present disclosure.

The occupancy probability model may be expressed as an inverse sensor model, and the inverse sensor model may be set based on a detection probability determined by classifying a location of a sample object and a surrounding area of the sample object with respect to the sample object.

Referring to FIG. 2, the position of ‘a’ may mean a peak point of a reception signal received by a radar sensor with respect to a sample object. A predetermined area may be set as the location of the object based on the location of ‘a’, and an area outside the predetermined area may be set as a surrounding area of the object. That is, the detection probability may be determined by dividing the location of the sample object and the surrounding area of the sample object based on the radar measurement value of the sample object, and based on this, the occupancy probability model or the inverse sensor model may be set.

A detection probability for a sample object according to the occupancy probability model may be expressed as shown in FIG. 2. For example, in the occupancy probability model, the detection probability may be expressed as height of a spring as shown in 200 of FIG. 2. Alternatively, in the occupancy probability model, the detection probability may be expressed in different colors according to a preset range as shown in 210 of FIG. 2. Alternatively, in the occupancy probability model, the detection probability may be expressed as a combination of a height and a different color, as shown in 220 of FIG. 2. That is, in the occupancy probability model, the detection probability may be expressed in various ways. Although 210 and 220 of FIG. 2 are expressed as a combination of three colors, the present invention is not limited thereto, and may be expressed as a combination of three or more colors.

Since the occupancy probability model includes the radar measurement value for the sample object and detection probability information on the measurement value, there may be determined the detection probability for the radar measurement value calculated for the object from the vehicle surrounding information using the occupancy probability model.

In FIG. 2, an occupancy probability model for one sample object is shown, but there may be determined a detection probability according to each measurement value for a plurality of sample objects, and there may be set as an occupancy probability model by combining the calculated detection probabilities.

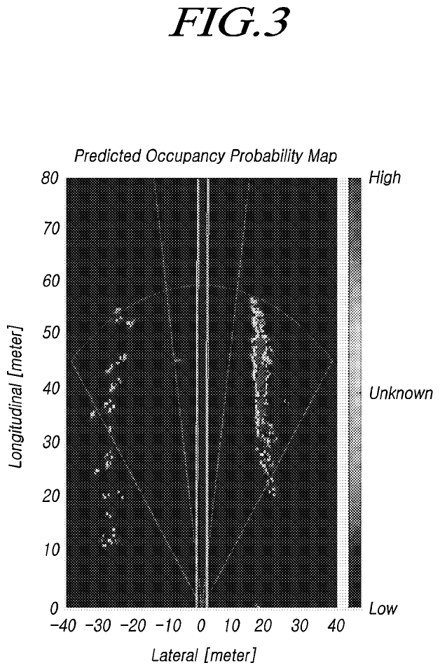

FIG. 3 illustrates a predicted occupancy probability grid map according to an embodiment of the present disclosure.

Referring to FIG. 3, the predicted occupancy probability grid map may be generated by reflecting the predicted occupancy probability calculated in the cumulative grid map.

The predicted occupancy probability grid map may be generated based on the cumulative grid map in which vehicle driving information according to a change in the driving state of the host vehicle is reflected. As described above, the prior probability of the object is calculated based on the cumulative grid map, the predicted occupancy probability of the object is calculated based on the calculated prior probability and the vehicle surrounding information received from the radar sensor thereafter, and a predicted occupancy probability grid map may be generated by reflecting the predicted occupancy probability in the cumulative grid map.

Grid points for an object represented on the predicted occupancy probability grid map may have a value between 0 and 1, and may be expressed by changing the contrast or color according to the value.

For example, based on the set contrast corresponding to a value between 0 and 1, the grid points may be expressed from a dark point having a high detection probability to a bright point having a low detection probability, or from a bright point having a high detection probability to a dark point having a low detection probability.

For another example, grid points may be expressed in different colors from a point having a high detection probability to a point having a low detection probability according to a color set corresponding to a value between 0 and 1.

However, it is an example that the grid points are expressed differently by contrast or color, and there may be expressed in different expression formats that can be distinguished based on the values of grid points.

The predicted occupancy probability grid map may be continuously updated, as described above, so that the accuracy of the predicted occupancy probability grid map can be further improved.

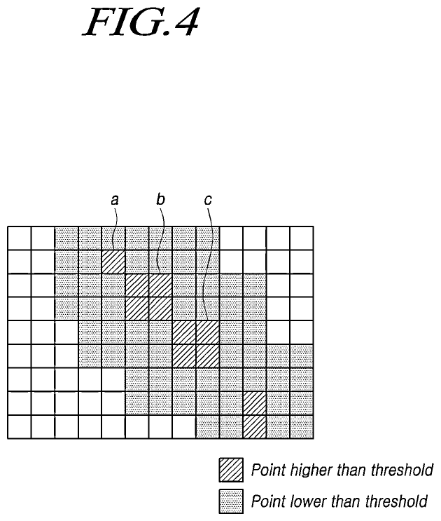

FIG. 4 is a diagram for explaining setting of an object area according to an embodiment of the present disclosure.

The determiner 130 may extract a point higher than a threshold, which may be preset in the predicted occupancy probability grid map and may variably change according to the probability distribution of the predicted occupancy probability grid map, and may set the extracted area (a, b, c, etc.) as an object area.

As shown in FIG. 4, based on the threshold which may be preset in the predicted occupancy probability grid map and may variably change according to the probability distribution of the predicted occupancy probability grid map, the points at which the predicted occupancy probability is calculated may be divided into a point greater than or equal to a threshold and a point less than a threshold lower than the threshold. Points higher than the threshold may mean that the probability of being occupied by the object is high, and points lower than the threshold may indicate noise. Accordingly, a noise signal may be removed by extracting a point higher than a threshold, which may be preset in the predicted occupancy probability grid map and may variably change according to the probability distribution of the predicted occupancy probability grid map, and only points with a high probability of being occupied by an object may be extracted and set as the object area, so that the object area can be set more accurately.

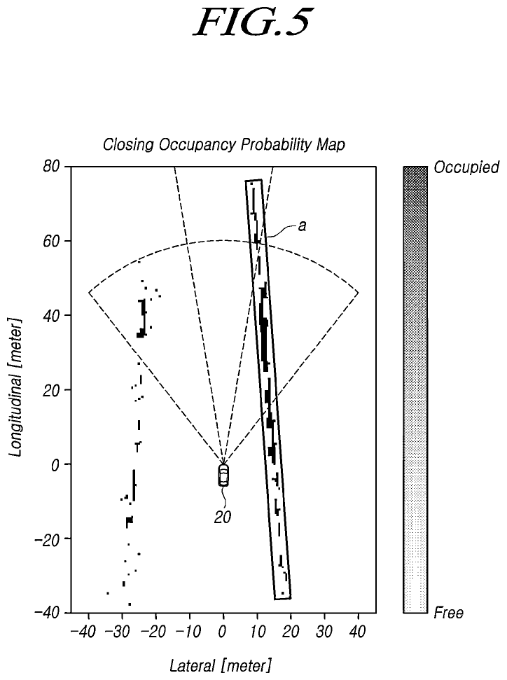

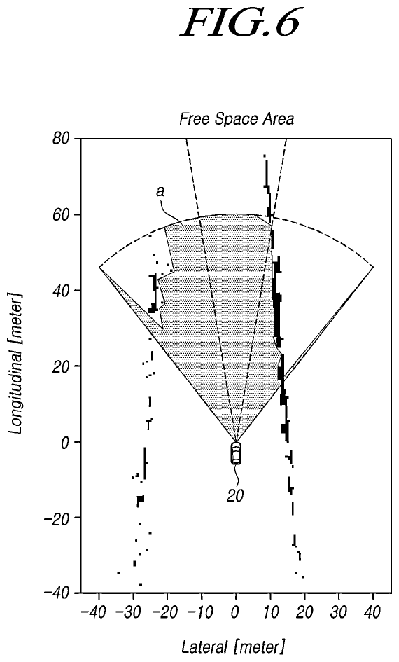

FIG. 5 is a diagram for explaining determining a stationary object based on an object area according to an embodiment of the present disclosure. FIG. 6 is a diagram for explaining determining a free space based on an object area according to an embodiment of the present disclosure.

Referring to FIG. 5, a stationary object may be determined based on the object area. For example, in the case that the set object area is continuous for more than a preset section, there may be determined as a stationary object based on the continuous object area (a).

In addition, the stationary object may be determined separately. For example, the stationary object may be determined by being divided into a guardrail, a road soundproof wall, etc. based on object information such as thickness and length of each of the preset and stored guardrails and road soundproof walls.

Referring to FIG. 6, the free space may be determined based on the object area.

For example, within the range detectable by the radar sensor, the area (a) excluding the set object area may be determined as a free space. The free space may mean an area in which the host vehicle 20 can travel.

The determiner 130 may determine the space (a) excluding the object area in the detection area detectable by the radar sensor as a free space, and determine that the area outside the detection area is not a free space. It is possible to set an accurate object area based on the predicted occupancy probability grid map, and based on this, the free space is determined within the detection area of the radar sensor, so that the free space can be more accurately determined.

However, the present invention is not limited thereto, and the determiner 130 may determine a space other than an object area within a preset area as a free space. For example, the determiner 130 may include an area outside the detection area detectable by the radar sensor in the preset area, and may determine a space other than the set object area in the preset area as a free space.

As described above, the radar control device 10 of the present disclosure may generate a predicted occupancy probability grid map for an object based on a signal received from a radar sensor, set an object area based on the predicted occupancy probability grid map, and determine the stationary object and the free space around the host vehicle based on this, so that it is possible to more accurately determine the stationary object and the free space.

The above-described radar control device 10 may be implemented as an electronic control unit (ECU), a microcomputer, or the like.

In an embodiment, the radar control device 10 may be implemented as an electronic control unit. The electronic control unit may include one or more elements of one or more processors, memories, storage, user interface inputs and user interface outputs, which may communicate with each other via a bus. Further, the electronic control unit may also include a network interface for connecting to the network. The processor may be a CPU or a semiconductor device that executes processing instructions stored in memory and/or storage. Memory and storage may include various types of volatile/non-volatile storage media. For example, memory may include ROM and RAM.

Hereinafter, it will be described a radar control method using the radar control device 10 of the present disclosure.

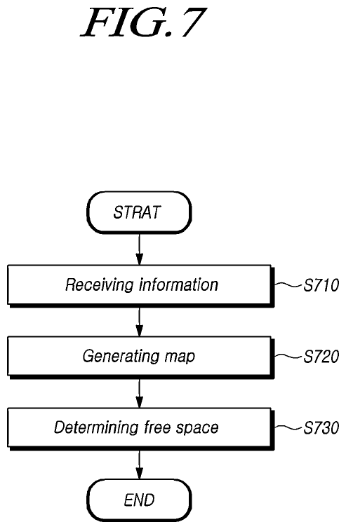

FIG. 7 is a flowchart illustrating a radar control method according to an embodiment of the present disclosure.

Referring to FIG. 7, the radar control method according to the present disclosure may include vehicle surrounding information receiving step (S710) of receiving information about a vehicle around the host vehicle 20 from a radar sensor, a map generation step (S720) of determining a radar measurement value for an object based on vehicle driving information, determining a detection probability for the measurement value, and generating a predicted occupancy probability grid map based on the detection probability, and a free space determination step (S730) of determining a free space in which the host vehicle can travel based on the predicted occupancy probability grid map.

Here, the measurement value may be determined by performing Fast Fourier Transform (FFT) on vehicle surrounding information.

The map generation step (S720) may include determining a detection probability for the measurement value based on a preset occupancy probability model.

In addition, the information receiving step (S710) may further include receiving vehicle driving information from a plurality of sensors, and the map generation step (S720) may include generating a grid map based on the detection probability and generating the cumulative grid map in which the grid map is updated by using the vehicle driving information.

The information receiving step (S710) may further include receiving vehicle driving information from a plurality of sensors.

The plurality of sensors may include, for example, a vehicle speed sensor and a yaw rate sensor. However, the present invention is not limited thereto, and there may be used any sensor capable of confirming driving information of the vehicle.

The map generation step (S720) may include generating a grid map based on the detection probability. An object in the grid map may be generated based on a detection probability calculated by considering the location of the object and the surrounding area of the object.

In the map generation step (S720), the cumulative grid map in which the grid map is updated may be generated using vehicle driving information. For example, in the map generation step (S720), the grid map may be updated through rigid transformation of an object of which a detection probability is represented in the grid map using vehicle driving information.

In the map generation step (S720), the cumulative grid map may be generated by reflecting the updated grid map to the previously generated grid map. This is to maintain detection probability information on an object until a predicted occupancy probability, which will be described later, is calculated.

The information receiving step (S710) may further include receiving the vehicle surrounding information from the radar sensor every preset period, and the map generation step (S720) may include determining the predicted occupancy probability based on the vehicle surrounding information received after generating the cumulative grid map and the cumulative grid map, and generating a predicted occupancy probability grid map based on the predicted occupancy probability.

The information receiving step (S710) may further include receiving the vehicle surrounding information from the radar sensor at preset period. This may be used to update the cumulative grid map every preset period, and may be used to determine a predicted occupancy probability based on the updated cumulative grid map.

The vehicle surrounding information used to generate the cumulative grid map may be referred to as vehicle surrounding information at a previous time point, and the vehicle surrounding information received after the cumulative grid map is generated may be referred to as vehicle surrounding information at the current time point. Hereinafter, description will be provided based on the premise of the time points.

In the map generation step (S720), the predicted occupancy probability may be determined based on the vehicle surrounding information and the cumulative grid map received after the cumulative grid map is generated.

For example, the map generation step (S720) may include determining a measurement value and a detection probability from vehicle surrounding information at the current time point, and determining a prior probability for a grid point of which the detection probability is displayed from the cumulative grid map. In addition, the map generation step (S720) may include determining the detection probability for an object at the current time point and a predicted occupancy probability as a posterior predicted probability which is calculated by applying Bayesian Theory to a prior probability calculated from cumulative grid map.

The map generation step (S720) may include generating a predicted occupancy probability grid map based on the predicted occupancy probability. For example, the map generation step (S720) may include generating the predicted occupancy probability grid map by reflecting the determined predicted occupancy probability on the cumulative grid map. Accordingly, the predicted occupancy probability grid map may refer to a grid map in which a predicted occupancy probability calculated based thereon is reflected as well as a measurement value of the radar.

The map generation step (S720) may include continuously updating the predicted occupancy probability map. For example, after the predicted occupancy probability map is generated, the predicted occupancy probability map may be accumulated and updated using vehicle state information received from a plurality of sensors. In addition, the predicted occupancy probability may be determined by using the vehicle surrounding information received from the radar sensor after generating the predicted occupancy probability map and the accumulated/updated predicted occupancy probability map. In addition, the predicted occupancy probability map may be continuously updated by reflecting the calculated predicted occupancy probability in the accumulated/updated predicted occupancy probability map. Therefore, there may be further improved the accuracy of the predicted occupancy probability grid map by updating.

The free space determination step (S730) may include determining a free space in which the host vehicle can travel based on the predicted occupancy probability grid map. For example, the free space determination step (S730) may include extracting a point higher than a threshold in the predicted occupancy probability grid map, setting an object area based on the extracted point, and determining a free space based on the set object area.

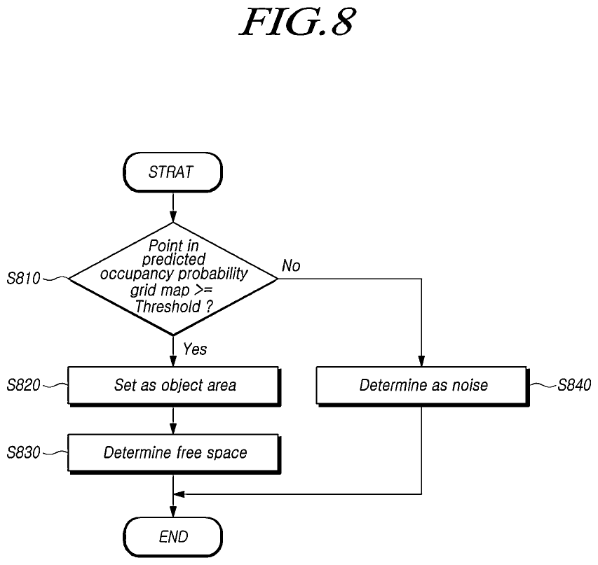

FIG. 8 is a diagram for describing in detail determining a free space of a radar control method according to an exemplary embodiment.

Referring to FIG. 8, the free space determination step (S730) of the radar control method may include determining whether a point in the predicted occupancy probability grid map is higher than a threshold (S810).

The threshold may be set as a numerical value for the occupancy probability, and may be a criterion for determining whether the corresponding point is occupied by an object. The threshold may be preset, but is not limited thereto. For example, the threshold may be variably changed according to the probability distribution of the predicted occupancy probability grid map.

In the free space determination step (S730), a point in the predicted occupancy probability grid map may be extracted, a point higher than a threshold, and an object area may be set based on the extracted point (S820). In addition, the free space determination step (S730) may include determining the free space based on the set object area (S830). However, the present invention is not limited thereto, and the free space determination step (S730) may include determining a stationary object based on the set object area.

Meanwhile, in the free space determination step (S730), points lower than the threshold in the predicted occupancy probability grid map may be determined as noise (S840).

As described above, in the radar control method, a detection probability is calculated for all measurement values, a predicted occupancy probability grid map is generated based on the calculated detection probability, and noise is removed by comparing with a preset threshold value for each point of the generated predicted occupancy probability grid map. In addition, the free space in which the host vehicle can travel is determined by setting the object area based on points higher than the threshold, so that it is possible to improve the accuracy of free space determination.

As described above, the radar control device and method according to the present disclosure may generate a predicted occupancy probability grid map for an object based on a signal received from a radar sensor, set an object area based on the predicted occupancy probability grid map, and determine a stationary object and the free space around the host vehicle based on this, so that it is possible to more accurately determine the stationary object and the free space.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A radar control device comprising:
a receiver configured to receive vehicle surrounding information about surroundings of a host vehicle from a radar sensor;
a map generator configured to determine a measurement value of the radar sensor for an object from the vehicle surrounding information, determine a detection probability for the measurement value, and generate a predicted occupancy probability grid map based on the detection probability; and
a determiner configured to determine a free space in which the host vehicle can travel based on the predicted occupancy probability grid map.

2. The radar control device of claim 1, wherein the measurement value is determined by performing Fast Fourier Transform (FFT) on the vehicle surrounding information.

3. The radar control device of claim 1, wherein the map generator determines the detection probability for the measurement value based on a preset occupancy probability model.

4. The radar control device of claim 3, wherein the receiver further receives vehicle driving information from a plurality of sensors,
wherein the map generator generates a grid map based on the detection probability, and generates a cumulative grid map in which the grid map is updated using the vehicle driving information.

5. The radar control device of claim 4, wherein the plurality of sensors comprise a vehicle speed sensor and a yaw-rate sensor.

6. The radar control device of claim 4, wherein the receiver further receives the vehicle surrounding information from the radar sensor at a preset period,
wherein the map generator determines a predicted occupancy probability based on the cumulative grid map and vehicle surrounding information received after the cumulative grid map is generated, and generates the predicted occupancy probability grid map based on the predicted occupancy probability.

7. The radar control device of claim 1, wherein the determiner extracts a point higher than a threshold in the predicted occupancy probability grid map, sets an object area based on the extracted point, and determines the free space based on the set object area.

8. The radar control method comprising:
receiving vehicle surrounding information about surroundings of a host vehicle from a radar sensor;
determining a measurement value of the radar sensor for an object from the vehicle surrounding information, determining a detection probability for the measurement value, and generating a predicted occupancy probability grid map based on the detection probability; and
determining a free space in which the host vehicle can travel based on the predicted occupancy probability grid map.

9. The radar control method of claim 8, wherein the measurement value is determined by performing Fast Fourier Transform (FFT) on the vehicle surrounding information.

10. The radar control method of claim 8, wherein determining a detection probability comprises determining the detection probability for the measurement value based on a preset occupancy probability model.

11. The radar control method of claim 10, wherein the receiving further comprises receiving vehicle driving information from a plurality of sensors,
wherein the generating comprises generating a grid map based on the detection probability, and generating a cumulative grid map in which the grid map is updated using the vehicle driving information.

12. The radar control method of claim 11, wherein the plurality of sensors include a vehicle speed sensor and a yaw-rate sensor.

13. The radar control method of claim 11, wherein the receiving further comprises receiving the vehicle surrounding information from the radar sensor at a preset period,
wherein the generating comprises determining a predicted occupancy probability based on the cumulative grid map and vehicle surrounding information received after the cumulative grid map is generated, and generating the predicted occupancy probability grid map based on the predicted occupancy probability.

14. The radar control method of claim 8, wherein the determining a free space comprises extracting a point higher than a threshold in the predicted occupancy probability grid map, setting an object area based on the extracted point, and determining the free space based on the set object area.
